(19) United States
(12) Patent Application Publication
(10) Pub. No.: US 2019/0258197 A1
(43) Pub. Date: Aug. 22, 2019

(54) IMAGE FORMING APPARATUS

(71) Applicant: Konica Minolta, Inc., Tokyo (JP)

(72) Inventor: Daiki HIRATA, Okazaki-shi (JP)

(21) Appl. No.: 16/246,310

(22) Filed: Jan. 11, 2019

(30) Foreign Application Priority Data
Feb. 19, 2018 (JP) 2018-026780

(51) Int. Cl. G03G 15/23; G03G 15/00; B65H 29/58; B65H 51/30

(52) U.S. Cl. CPC G03G 15/234; G03G 15/6573; G03G 2215/00949; B65H 51/30; G03G 2215/00945; B65H 29/58

(57) ABSTRACT

An image forming apparatus includes: an image former; a main conveyance path that conveys the sheet to a downstream side; a reverse conveyance path that reverses the sheet; a two-side conveyance path that branches at a first branch point and sends the sheet back into the image former; a reverse ejection conveyance path that branches at a second branch point and sends the sheet to a downstream side of the main conveyance path; a two-side roller that is rotating to reverse a direction of conveyance of the sheet and send the sheet into the two-side conveyance path; and a reversing roller that is rotating to reverse the direction of conveyance of the sheet and send the sheet into the reverse ejection conveyance path, wherein the reversing roller is disposed on a downstream side of the two-side roller, as viewed from an ejection side of the image former.

The entire disclosure of Japanese patent Application No. 2018-026780, filed on Feb. 19, 2018, is incorporated herein by reference in its entirety.

### BACKGROUND

### Technological Field

The present invention relates to an image forming apparatus.

### Description of the Related Art

An image forming apparatus such as a printer, a copying machine, or a multifunction peripheral prints an image on one side or both sides of a sheet, and ejects the printed sheet onto a sheet catch tray or into an apparatus in the succeeding stage from an ejection port. Sheet ejection in one-side printing may be normal ejection for ejecting the printed sheet without reversing the printed sheet, or reverse ejection for ejecting the printed sheet after reversing the printed sheet.

A known configuration of an image forming apparatus that is capable of switching between normal ejection and reverse ejection and is capable of two-side printing includes a reverse conveyance path for reverse ejection and a two-side conveyance path for returning a sheet subjected to one-side printing to the printing position in two-side printing. In this configuration, the conveyance distance in reverse ejection can be made shorter than the corresponding conveyance distance in a configuration in which a sheet is made to pass through a two-side conveyance path and is then reversed.

The reverse conveyance path branches from the main conveyance path through which each sheet passes at a time of normal ejection. The reverse conveyance path includes a switchback conveyance unit with a length equal to or greater than the length with which a sheet of the maximum size can be contained in the switchback conveyance unit. This switchback conveyance unit is connected to a reverse ejection conveyance path that branches from the reverse conveyance path and joins the main conveyance path. In reverse discharge, the printed sheet is temporarily drawn into the switchback conveyance unit, and is then send from the switchback conveyance unit into the reverse ejection conveyance path. This process is called switchback conveyance. The sheet then returns to the main conveyance path via the reverse ejection conveyance path, and moves to the ejection port.

In a case where reverse ejection is performed in a job for performing printing on sheets, the sheet interval should be at least equal to the switchback conveyance distance so that sheets being continuously conveyed are prevented from colliding with one another in the reverse conveyance path. However, to achieve a high printing productivity, the sheet interval is preferably short when the sheets are passing through the printing position. Therefore, accelerated conveyance control is normally performed so that the conveyance velocity of a sheet after printing becomes higher than the conveyance velocity before the end of printing.

Image forming apparatuses having a configuration that includes a two-side conveyance path that is a branch path branching from a reverse conveyance path at a branch point (branch point PC) different from the branch point (branch point PB) between the reverse conveyance path and a reverse ejection conveyance path are disclosed as conventional techniques relating to reverse ejection and two-side printing in JP 2017-142365 A, JP 2001-122494 A, and JP 2010-223983 A.

The image forming apparatus illustrated in FIG. 1 of JP 2017-142365 A includes a main conveyance path (23), a first reverse conveyance path (24a) equivalent to the reverse conveyance path, a third reverse conveyance path (24c) equivalent to the two-side conveyance path, and a fourth reverse conveyance path (24d) equivalent to the reverse ejection conveyance path. In the configuration of the image forming apparatus disclosed in JP 2017-142365 A, the distance D1 from the branch point (branch point PA) between the main conveyance path and the reverse conveyance path to the branch point PB between the reverse conveyance path and the reverse ejection conveyance path is shorter than the distance D2 from the branch point PA to the branch point PC between the reverse conveyance path and the two-side conveyance path.

In the configuration of the image thrilling apparatus illustrated in FIG. 2 of JP 2001-122494 A. the distance D1 from the branch point PA to the branch point PR is also shorter than the distance D2 from the branch point PA to the branch point PC. This image forming apparatus includes a roller (15) for switchback conveyance to send a sheet into the reverse ejection conveyance path, and a roller (16) for switchback conveyance to send a sheet into the two-side conveyance path.

In the configuration of the reversing unit of the image forming apparatus illustrated in FIG. 2 of IP 2010-223983 A, the distance D1 is longer than the distance D2, and the same roller (213) is used for the switchback conveyance at a time of reverse Election and the switchback conveyance at a time of two-side printing.

In the above configurations disclosed in JP 2017-142365 A and JP 2001-122494 A, it is difficult to adjust the interval between the current sheet and the succeeding sheet to a sufficiently wide interval that does not hinder the switchback in reverse Election, without degrading the productivity of image Formation. In other words, for the preceding sheet to move past the branch point PB before the top edge of the succeeding sheet arrives at the branch point PB, it is necessary to increase the velocity of the accelerated conveyance to a velocity much higher than the velocity in the printing step. However, an increase in velocity will lead to an increase in power consumption, and also cause skewing in many sheets. If the conveyance in the printing step is made slower to maintain a sufficient sheet interval for reverse ejection, the productivity of image formation will become lower.

In the above described configuration disclosed in JP 2010-223983A, the same roller is used for the switchback in reverse ejection and for the switchback in two-side printing. Therefore, in two-side printing, the sheet needs to he pulled in until the bottom edge of the sheet moves past the branch point PB, and, after that, switchback needs to be performed on the sheet. For this reason, the length of the sheet conveyance path in two-side printing becomes longer than necessary. Therefore, it is difficult to increase the productivity of two-side printing. If the conveyance velocity is made higher to achieve a higher productivity, power consumption increases, and skewing is often caused in sheets. Further, in a case where the moving direction of a sheet subjected to switchback with the shared roller is changed at a time of reverse ejection and at a time of two-side printing, a mechanism that actively changes the raveling direction needs to be provided at the branch point PB, and drive control needs to be performed. The use of such an active component will lead to an increase in the cost of the image thrilling apparatus.

### SUMMARY

The present invention has been made in view of the above problems, and aims to provide an image forming apparatus that increases the productivity of two-side printing and the productivity of one-side printing involving reverse ejection more easily than in conventional cases.

To achieve the abovementioned object, according to an aspect of the present invention, an image forming apparatus reflecting one aspect of the present invention comprises: an image former that forms an image on a sheet; a main conveyance path that conveys the sheet being ejected from the image former to a downstream side; a reverse conveyance path that branches from the main conveyance path and reverses the sheet; a two-side conveyance path that branches at a first branch point of the reverse conveyance path and sends the sheet hack into the image former for two-side printing; a reverse ejection conveyance path that branches at a second branch point of the reverse conveyance path and sends the sheet to a downstream side of the main conveyance path for reverse ejection; a two-side roller that is disposed in the reverse conveyance path, the two-side roller rotating to reverse a direction of conveyance of the sheet being conveyed in the reverse conveyance path and send the sheet into the two-side conveyance path; and a reversing roller that is disposed in the reverse conveyance path, the reversing roller rotating to reverse the direction or conveyance of the sheet being conveyed to the reverse conveyance path and send the sheet into the reverse ejection conveyance path, wherein the reversing roller is disposed on a downstream side of the two-side roller, as viewed from an ejection side of the image former.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1. is a diagram schematically showing an example configuration of an image forming apparatus according to an embodiment of the present invention;

FIG. 2 is a diagram showing the configuration of the principal components related to sheet ejection in the image forming apparatus;

FIG. 3 is a diagram schematically showing the positional relationship between a reversing roller and a two-side roller;

FIGS. 4A and 4B are diagrams showing example configurations of return stoppers; and

FIG. 5 schematically shows another example configuration of the principal components related to sheet ejection.

### DETAILED DESCRIPTION OF EMBODIMENTS

Hereinafter, one or more embodiments of the present invention will be described with reference to the drawings. However, the scope of the invention is not limited to the disclosed embodiments.

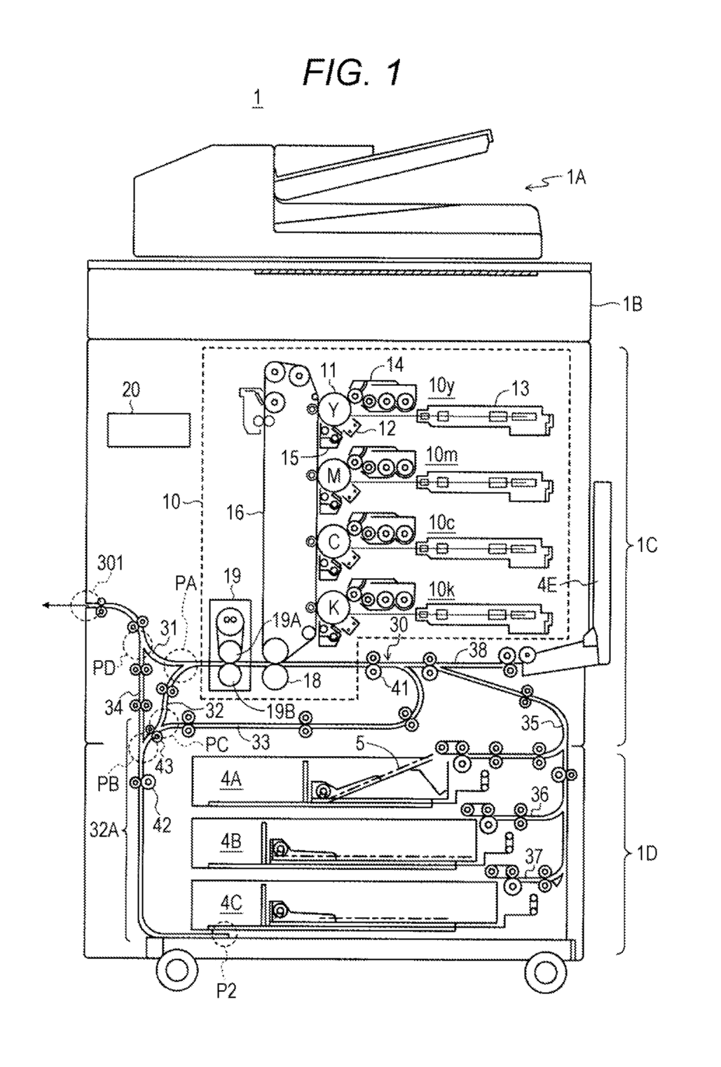

FIG. 1 schematically shows the configuration of an image forming apparatus 1 according to an embodiment of the present invention.

In FIG. 1, the image forming apparatus 1 is a multifunctional machine or a multifunction peripheral (MFP) that integrates the functions of a copying machine, a printer, an image reader, a facsimile machine, and the like. The image forming apparatus 1 includes an automatic document feeder (ADF) 1A, a flatbed scanner 1B, a color printer 1C, and a drawer-type sheet feed cabinet 1D. The image forming apparatus 1 also includes a control circuit 20 that controls operation of the image forming apparatus 1. The control circuit 20 includes a processor that executes a control program and its peripheral devices (a ROM, a RAM, and the like).

The automatic document feeder 1A conveys a sheet-like document set on the document tray, to the reading position of the scanner 1B. The automatic document feeder 1A is designed to be opened and dosed as a cover that covers the platen glass of the scanner 1B.

The scanner 1B, reads an image of a document conveyed from the automatic document feeder 1A or a document placed on the platen glass, to generate image data.

The sheet feed cabinet 1D is disposed under the color printer 1C. The sheet feed cabinet 1D includes sheet feed cassettes 4A, 4B, and 4C for storing sheets (recording paper) 5. The sheet feed cabinet 1D removes a sheet 5 from a sheet feed cassette selected from among the sheet feed cassettes 4A, 4B, and 4C, and supplies the sheet 5 to the color printer 1C.

The color printer 1C prints a color or monochrome image on one side or both sides of the sheet 5 in a print job such as copying, network priming (PC printing), box printing, or facsimile reception.

The color printer 1C includes a tandem printer engine (an image former) 10 that forms an image by electrophotography. The printer engine 10 includes four imaging stations 10y, 10m, 10c, and 10k, an intermediate transfer belt 16, a secondary transfer roller 18, and a fixing device 19.

The imaging station 10y forms a yellow (Y) toner image, the imaging station 10m forms a magenta (M) toner image, and the imaging station 10c forms a cyan (C) toner image. The imaging station 10k forms a black (K) toner image.

The basic structures of the imaging stations 10y, 10m, 10c, and 10k are similar to each other, and each include a cylindrical photosensitive member 11, a charger 12, a print head 13, a developing device 14, and a cleaner 15.

The photosensitive member 11 is supported by a drum and rotates counterclockwise in the drawing. The charger 12 electrically charges the circumferential surface of the photosensitive member 11. The print head 13 forms an electrostatic latent image by emitting a laser beam onto the circumferential surface of the rotating photosensitive member 11. The developing device 14 applies toner onto the photosensitive member 11, and visualizes the electrostatic latent image as a toner image. The cleaner 15 removes the remaining toner from the photosensitive member 11 after the toner image is transferred in the primary transfer process.

In a color print mode, the imaging stations 10y through 10k each form a toner image. The formed toner images are transferred in the primary transfer process from the photosensitive members 11 to the intermediate transfer belt 16, which is a transfer member being used for all the four colors. At this point of time, the intermediate transfer belt 16 is being rotationally driven.

The Y toner image is first transferred, and the M toner image, the C toner image, and the K toner image are sequentially transferred onto the Y toner image. That is, for the four colors, primary transfer is performed in the order of Y, M, C, and K. To superimpose the four toner images appropriately on one another in the primary transfer, the timing to form each toner image is determined in accordance with the intervals among the imaging stations 10y through 10k and the moving speed of the intermediate transfer belt 16.

When the toner images transferred in the primary transfer process reach the secondary transfer roller 18. the toner images are transferred as a color toner image in a secondary transfer process onto a sheet 5 that has been removed from the sheet feed cassette 4A, for example, and been conveyed thereto via a timing roller 41. The sheet 5 having the toner image transferred onto one side thereof passes through the nip portion between rollers 19A and 19B of the fixing device 19. At the fixing device 19, the toner image is fixed to the sheet 5 by heating and pressure.

The sheet 5 that has passed through the fixing device 19 is sent to an ejection port 301, and is ejected onto a sheet catch tray (not shown) or an apparatus in the subsequent stage connected to the image forming apparatus 1. The apparatus in the subsequent stage may be a sorter, a finisher, or the like.

In the image forming apparatus 1, a conveyance path 30 that is a passage for the sheets 5 includes a main conveyance path 31 extending from the upstream side of the timing roller 41 to the ejection port 301 through the printer engine 10, and sub conveyance paths leading to the main conveyance path 31. The sub conveyance paths include not only sheet feed paths 35 through 38 that connect the sheet feed cassettes 4A through 4C or a manual feed tray 4E to the main conveyance path 31, but also a reverse conveyance path 32, a two-side conveyance path 33, and a reverse ejection conveyance path 34.

In the description below explanation of the configuration and operation of the image forming apparatus 1 centers on the portions of the conveyance path 30 related to reverse ejection and two-side printing.

The main conveyance path 31 conveys a sheet 5 that is to be discharged from the printer engine 10, to the ejection port 301 on the downstream side. That is, the main conveyance path 31 conveys the sheet 5 from right to left as viewed from the front side of the image forming apparatus 1. In other words, the direction of conveyance by the main conveyance path 31 is basically a horizontal direction. As the intermediate transfer belt 16 is located above such a main conveyance path 31 the sheet 5 is ejected in a face-up state in a case where normal ejection (non-reverse ejection) is performed in a one-side print job.

However, in a job for printing a document formed with more than one page in page number order, for example, each sheet is preferably ejected in a face-down state. In a case where stapling is performed in a later stage, it is necessary to perform reverse ejection, to put each sheet into a face-down state.

For this reason, the image forming apparatus 1 includes the reverse conveyance path 32 and the reverse ejection conveyance path 34.

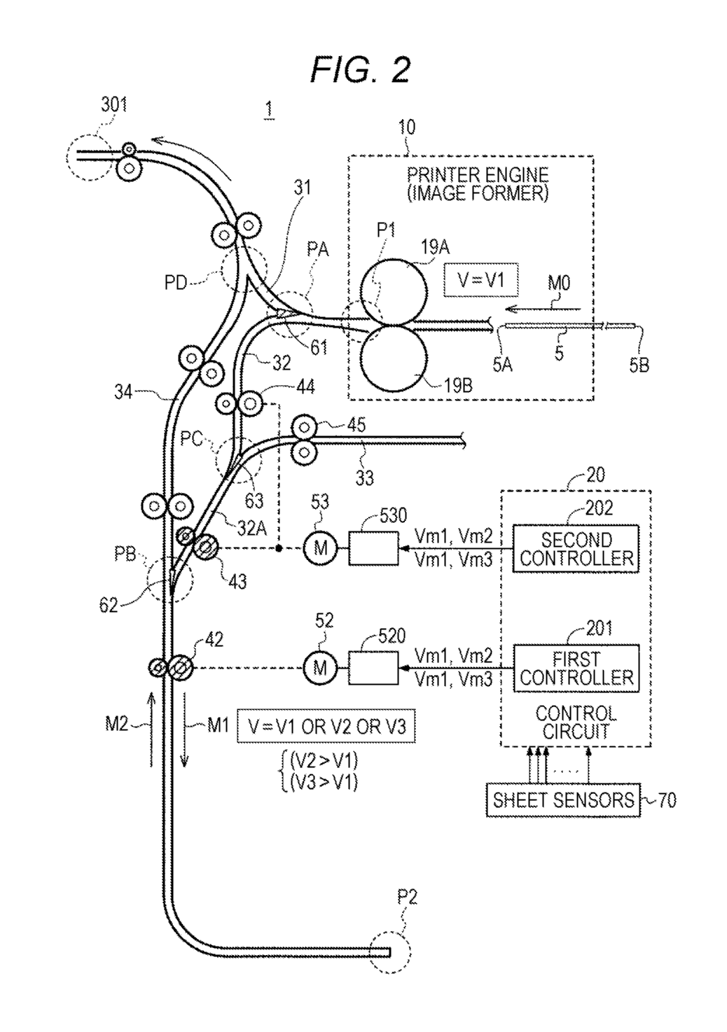

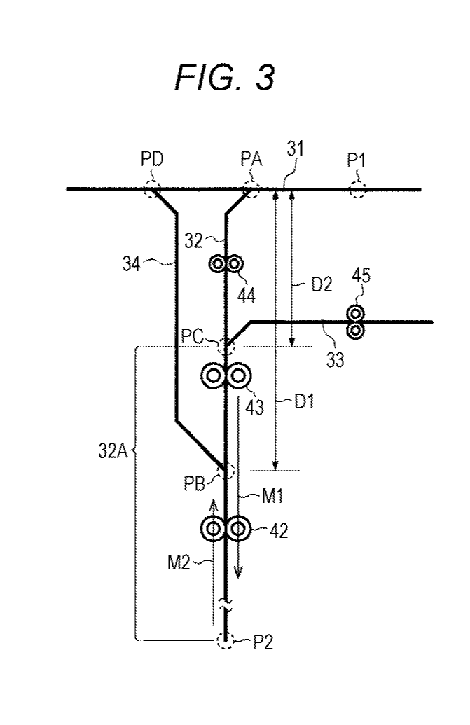

FIG. 2 shows the configuration of the principal components related to ejection of sheets 5 in the image forming apparatus 1. FIG. 3 schematically shows the positional relationship between a reversing roller 42 and a two-side roller 43.

The reverse conveyance path 32 is designed to branch downward form the main conveyance path 31 at a branch point PA so as to reverse a sheet 5. The reverse conveyance path 32 extends from the branch point PA to a terminal position P2 near the bottom surface of the image forming apparatus 1.

The two-side conveyance path 33 that branches to the right joins the reverse conveyance path 32 at a branch point PC in the reverse conveyance path 32. The two-side conveyance path 33 is a sub conveyance path for reversing a sheet 5 on which one-side printing has been performed in a two-side print job and sending the sheet 5 back into the printer engine 10. As shown in FIG. 1, the two-side conveyance path 33 extends horizontally from the branch point PC below the main conveyance path 31, and the right end portion of the two-side conveyance path 33 is bent upward in a semicircular shape, so that the two-side conveyance path 33 joins the main conveyance path 31 on the upstream side of the timing roller 41.

As shown in FIG. 3, the portion of the reverse conveyance path 32 from the branch point PC with the two-side conveyance path 33 to the terminal position P2 thrills a switchback conveyance unit 32A in which a sheet 5 moves in a downward direction M1 and in an upward direction M2 at a time of reverse ejection or two-side printing.

The reverse ejection conveyance path 34 is a sub conveyance path for sending a sheet 5 to a junction PD on the downstream side of the branch point PA in the main conveyance path 31 at a time of reverse ejection. The reverse ejection conveyance path 34 branches from the reverse conveyance path 32 to the left at a branch point PB in the reverse conveyance path 32, and extends upward to join the main conveyance path 31 at the junction PD.

The distance from the branch point PB to the terminal position P2 is set at a value equal to or greater than the length of a sheet 5 of the presumably largest size in the direction of conveyance.

As shown in FIG. 2, a guide mechanism 61 that actively switches the course of a sheet 5 conveyed from the printer engine 10 on the upstream side is disposed at the branch point PA. The guide mechanism 61 is driven by a solenoid or a motor, for example, and is controlled by the control circuit 20 so as to perform the operation described below.

The guide mechanism 61 guides a sheet 5 to be ejected in a normal manner or a sheet 5 on which two-side printing has been performed, toward the ejection port 301. The guide mechanism 61 also guides a sheet 5 to be subjected to reverse ejection or a sheet 5 on which one-side printing has been performed in a two-side printing operation, toward the reverse conveyance path 32.

Return stoppers 62 and 63 that restrict the course of a seat 5 by being displaced or deformed when pushed by the sheet 5 being conveyed are provided at the branch point PB and the branch point PC, respectively.

When a sheet 5 is conveyed in the reverse conveyance path 32 toward the downstream side, the return stopper 62 at the branch point PB guides the sheet 5 so that the sheet 5 moves downward along the reverse conveyance path 32. When a sheet 5 is conveyed in the reverse conveyance path 32 toward the upstream side, on the other hand, the return stopper 62 guides the sheet 5 so that the sheet 5 enters the reverse ejection conveyance path 34 from the reverse conveyance path 32.

When a sheet 5 is conveyed in the reverse conveyance path 32 toward the downstream side, the return stopper 63 at the branch point PC guides the sheet 5 so that the sheet 5 moves along the reverse conveyance path 32. When a sheet 5 is conveyed in the reverse conveyance path 32 toward the upstream side, on the other hand, the return stopper 63 guides the sheet 5 so that the sheet 5 enters the two-side conveyance path 33 from the reverse conveyance path 32.

In the image forming apparatus 1, the two branch points PB and PC in the reverse conveyance path 32 are in such a positional relationship that “the branch point PB is farther from the branch point PA than the branch point PC”. In the reverse conveyance path 32, two rollers for switchback conveyance, which are the reversing roller 42 and the two-side roller 43, are provided.

The reversing roller 42 is disposed between the branch point PB and the terminal position P2, and can rotate to reverse the direction of conveyance of a sheet 5 being conveyed in the reverse conveyance path 32 and send the sheet 5 into the reverse ejection conveyance path 34. The reversing roller 42 is rotationally driven by a motor 52.

The two-side roller 43 is disposed at a position that is located between the branch point PC and the branch point PB and is closer to the branch point PB than the branch point PC. The two-side roller 43 can rotate to reverse the direction of conveyance of a sheet 5 being conveyed in the reverse conveyance path 32 and send the sheet 5 into the two-side conveyance path 33. The two-side roller 43 is driven by a motor 53. The motor 53 is controlled independently of the motor 52

The motor 53 is also a drive source for a conveying roller 44 disposed between the branch point PA and the branch point PC. That is, the two-side roller 43 and the conveying roller 44 rotate forward or backward in synchronization with each other. The conveying roller 44 is designed to convey a sheet 5 to the downstream side of the branch point PC.

Motor drive circuits 520 and 530 that rotate the motor 52 and the motor 53 are controlled by a first controller 201 and a second controller 203 provided in the control circuit 20. In accordance with detection signals from seat sensors 70 disposed in the conveyance path 30, the controllers 201 and 202 instruct the drive circuits 520 and 530 to rotate the motors 52 and 53 at a predetermined rotation velocity at an appropriate timing.

As described above, the branch point PB is farther from the branch point PA than the branch point PC. Accordingly, the reversing roller 42 is provided on the downstream side if the two-side roller 43, as viewed from a speed increase reference position P1 located on the ejection side of the printer engine 10. The speed increase reference position P1 is a position in the vicinity of the downstream side of the nip portion between the fixing rollers 19A and 19B, or a position at which a sheet 5 moves out of the image forming zone in the conveyance path 30.

Referring to FIG. 2, an outline of conveyance using the reverse conveyance path 32 is now explained. Prior to the explanation, the top edge 5A and the bottom edge 5B of a sheet 5 are defined. The top edge 5A of a sheet 5 is the edge on the downstream side in a conveyance direction M0 when the sheet 5 passes through the printer engine 10. The bottom edge 5B of a sheet 5 is the edge on the upstream side in the conveyance direction M0 also when the sheet 5 passes through the printer engine 10. In switchback conveyance in the reverse conveyance path 32, when a sheet 5 is pulled into the switchback conveyance unit 32A, the top edge 5A of the sheet 5 becomes the from end in the moving direction M1 When a sheet 5 is sent out from the switchback conveyance unit 32A, the bottom edge 5B of the sheet 5 is the front edge in the moving direction M2.

In a job for performing reverse ejection, a sheet 5 is conveyed in the printer engine 10 in the direction M0 toward the ejection port 301. At this point, the conveyance velocity V is a processing speed V1 set in consideration of image quality and productivity. In the case of continuous printing, sheets 5 are sequentially sent out from the printer engine 10 at the processing speed V1, with predetermined sheet intervals being allowed.

Before the top edge 5A of the first sheet 5 arrives at the branch point PA, the guide mechanism 61 is made ready to guide the sheet 5 to the reverse conveyance path 32. Until the sheet 5 finishes passing through the speed increase reference position P1, the motors 52 and 53 driving the rollers in the reverse conveyance path 32 are controlled to rotate forward and convoy the sheet 5 in the direction M1 at the processing speed V1.

At the time when the bottom edge 5B of the sheet 5 has passed through the speed increase reference position P1, the conveyance velocity V of the sheet 5 is switched to an accelerated conveyance velocity V2 that is different from the processing speed V1. The accelerated conveyance velocity V2 is higher (greater) than the processing speed V1. As a result, the sheet interval between the current sheet and the succeeding sheet being conveyed at the processing speed V1 becomes longer with time.

At the time when the bottom edge 5B of the sheet 5 has passed through the branch point PB, the rotation of the reversing roller 42 is switched to reverse rotation, and the motor 52 is controlled so that the sheet 5 is conveyed in the direction M2 at the accelerated conveyance velocity V2. Before that, at the time when the bottom edge 5B of the sheet 5 has passed through the two-side roller 43, the rotation of the two-side roller 43 and the conveying roller 44 is decelerated from the accelerated conveyance velocity V2 to the processing speed V1, so that a preparation is made to accept the succeeding sheet. The direction of rotation remains the forward direction.

When the top edge 5A of the sheet 5 having entered the reverse ejection conveyance path 34 from the branch point PB has passed through the reversing roller 42, the rotation of the reversing roller 42 is returned from reverse rotation to forward rotation. The rotation velocity Vm of forward rotation varies depending on the sheet length. Specifically, in a case where the sheet length is longer than the distance from the speed increase reference position P1 to the reversing roller 42, the rotation velocity Vm is a rotation velocity Vm1 corresponding to the processing speed V1. In a case where the sheet length is shorter than the distance, the rotation velocity Vm is a rotation velocity Vm2 corresponding to the accelerated conveyance velocity V2.

The sheet 5 that has entered the reverse ejection conveyance path 34 and moved out of the reversing roller 42 is then conveyed by conveying rollers disposed in the reverse ejection conveyance path 34. The sheet 5 then enters the main conveyance path 31 at the junction PD and moves toward the ejection port 301.

In a case where the distance between the conveying roller provided on the downstream side of the junction PD in the main conveyance path 31 and the reversing roller 42 is shorter than the sheet length of a minimum-size sheet 5, the conveying rollers in the reverse ejection conveyance path 34 are not necessarily driven.

The succeeding sheet is conveyed in the same manner as the first sheet 5. Specifically, accelerated conveyance is started at the time when the bottom edge 5B of the succeeding sheet has passed through the speed increase reference position P1, and switchback conveyance is performed at the time when the bottom edge 5B has passed through the branch point PB. As a result, the succeeding sheet is ejected via the reverse ejection conveyance path 34.

In a two-side print job on the other hand, it is possible to alternately perform first-side printing on a sheet 5 and second-side printing on another sheet 5. In a case where such alternate printing is performed, sheets 5 that are supplied from the sheet feed paths 35 through 38 and have not been subjected to printing, and sheets 5 that have returned to the upstream side of the printer engine 10 through the two-side conveyance path 33 are alternately supplied to the secondary transfer position. Accordingly, sheets 5 on which the first-side printing has just been performed (sheets to be sent into the two-side conveyance path 33), and sheets 5 on which the second-side printing has been performed (sheets not to he sent into the two-side conveyance path 33) are alternately ejected from the printer engine 10.

In other words, in a case where two-side printing is performed, the sheet interval between sheets 5 to be subjected to switchback conveyance in the reverse conveyance path 32 is at least longer than the sheet length of each sheet 5, compared with the sheet interval in the case of reverse ejection.

In a two-side print job, before the top edge 5A of a sheet 5 to be subjected to switchback conveyance arrives at the branch point PA, the guide mechanism 61 is made ready to guide the sheet 5 to the reverse conveyance path 32. Until the sheet 5 finishes passing through the speed increase reference position P1, the motors 52 and 53 driving the rollers in the reverse conveyance path 32 are controlled to rotate forward and convey the sheet 5 in the direction M1 at the processing speed V1.

At the time when the bottom edge 5B of the sheet 5 has passed through the speed increase reference position P1, the conveyance velocity V of the sheet 5 is switched to an accelerated conveyance velocity V3 that is different from the processing speed V1. The accelerated conveyance velocity V3 is higher than the processing speed V1. The accelerated conveyance velocity V may be the same as or different from the accelerated conveyance velocity V2 at a time of reverse ejection. In either case, the sheet interval between the current sheet 5 and the next sheet 5 to be subjected to switchback conveyance becomes longer with time, because of the switching of the conveyance velocity V.

At the time when the bottom edge 5B of the sheet 5 has passed through the branch point PC, the rotation of the two-side roller 43 and the reversing roller 42 is switched to reverse rotation, and the motors 52 and 53 are controlled so that the sheet 5 is conveyed in the direction M2 at the accelerated conveyance velocity V3. The conveying roller 44 synchronized with the two-side roller 43 also rotates in the reverse direction.

In parallel with this, the guide mechanism 61 is temporarily switched to a mode for guiding sheets 5 to the main conveyance path 31 from a mode for guiding sheets 5 to the reverse conveyance path 32, so that a preparation is made to eject sheets 5 on which the second-side printing has been performed.

When the top edge 5A of the sheet 5 having entered the two-side conveyance path 33 from the branch point PC has passed through the two-side roller 43, the rotation of the two-side roller 43 and the reversing roller 42 is returned from reverse rotation to forward rotation. The rotation velocity Vm of the forward rotation is the rotation velocity Vm1 corresponding to the processing speed V1.

The sheet 5 that has entered the two-side conveyance path 33 and moved out of the two-side roller 43 is conveyed by a conveying roller 45 provided in the two-side conveyance path 33, and enters the main conveyance path 31 on the upstream side of the printer engine 10.

The succeeding sheet on which the second-side printing has not been performed yet is conveyed in the same manner as the first sheet 5. Specifically, accelerated conveyance is started at the time when the bottom edge 5B of the succeeding sheet has passed through the speed increase reference position P1, and switchback conveyance is performed at the time when the bottom edge 5B has passed through the branch point PC. As a result, the succeeding sheet is sent into the two-side conveyance path 33.

As shown in FIG. 3. the distance D1 between the branch point PA and the branch point PB is longer than the distance D2 between the branch point PA and the branch point PC. This facilitates the increase in the sheet interval during reverse ejection without lowering the productivity of two-side printing, compared with the increase in the sheet interval in a case where the distance D1 is shorter than the distance D2 as in the conventional examples. This aspect is described below in detail.

To prevent sheets 5 From colliding against each other during reverse ejection, the entire preceding sheet 5 needs to he sent into the reverse ejection conveyance path 34 from the reverse conveyance path 32, before the succeeding sheet 5 arrives at the branch point PB.

The longer the distance D1, the longer the time of conveyance from the speed increase reference position P1 to the branch point PB at the accelerated conveyance velocity V2. Accordingly, the sheet interval between the current sheet and the succeeding sheet being conveyed at the processing speed V1 becomes wider. The distance D1 should be set so that an appropriate sheet interval can be maintained without excessively increasing the accelerated conveyance velocity V2.

it is possible to maintain an appropriate sheet interval by sufficiently increasing the distance D1 only for reverse ejection. However, in a case where the reverse conveyance path 32 is used not only for reverse ejection but also for two-side printing, if a structure in which the distance D1 is shorter than the distance D2 as its the conventional examples is adopted, the conveyance distance in two-side printing becomes unnecessarily long, resulting in decrease in the productivity of two-side printing.

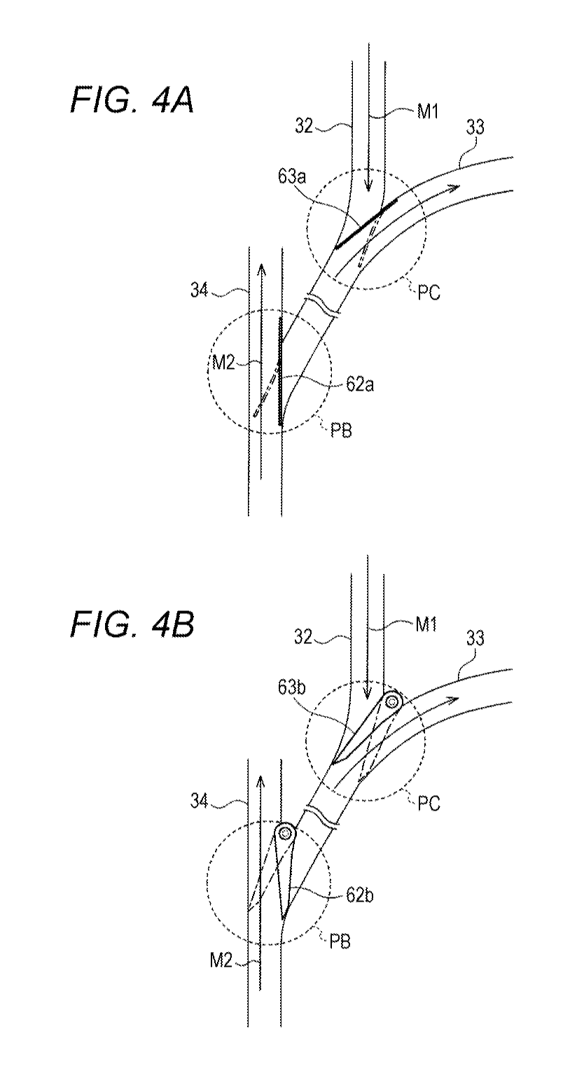

FIGS. 4A and 4B show example configurations of the return stoppers 62 and 63.

Return stoppers 62a and 63a shown in FIG. 4A are thin plate-like flexible members such as resin films or mica sheets. One end of each of the return stoppers 62a and 63a is fixed to a conveyance guide so that movement of sheets 5 from the lower side to the upper side in the reverse conveyance path 32 is blocked at the branch points PB and PC. When a sheet 5 is conveyed from the upper side, the unfixed portions are pushed and deformed by the sheet 5. The sheet 5 then keeps moving.

Return stoppers 62b and 63b shown in FIG. 4B are movable claw mechanisms. The return stoppers 62b and 63b are normally pushed and positioned by springs so that upward movement of sheets 5 from the lower side to the upper side in the reverse conveyance path 32 is blocked at the branch points PB and PC. When a sheet 5 is conveyed from the upper side, the unfixed portions are pushed and displaced by the sheet 5. The sheet 5 then keeps moving.

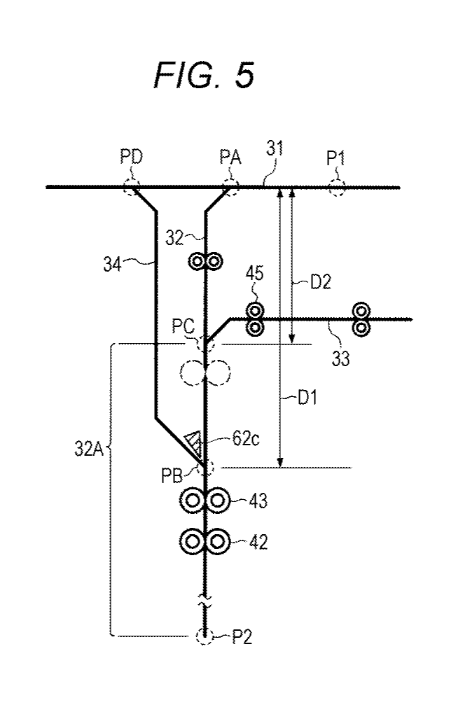

FIG. 5 schematically shows another example configuration of the principal components related to ejection of sheets 5.

In the example shown in FIG. 5, the positional relationship between the branch point PB and the branch point PC of the reverse conveyance path 32 is the same as the positional relationship in the example shown in FIGS. 1 through 3. The differences from the example shown in FIGS. 1 through 3 are that the two-side roller 43 is disposed between the branch point PB and the reversing roller 42, and, instead of a return stopper, a guide mechanism 62c that actively switches the course of a sheet 5 is disposed at the branch point PB. In the example shown in FIG. 5, the reversing roller 42 is also disposed on the downstream side of the two-side roller 43, as viewed from the speed increase reference position P1 located on the ejection side of the printer engine 10.

According to the above embodiment, it is possible to increase the conveyance distance D1 related to the increase in the sheet interval during reverse ejection without increasing the conveyance distance of a sheet 5 during two-side printing, and the productivity of two-side printing and one-printing involving reverse ejection can be made higher than the productivity in conventional cases.

According to the above described embodiment, the two-side roller 43 is disposed between the branch point PB and the branch point PC, and thus, the effects (1) through (3) described below are achieved.

(1) When the direction of conveyance of a sheet 5 is reversed, the bottom edge of sheet 5 is held by the return stopper 63 at the branch point PC, so that the top edge of the sheet 5 in the moving direction thereof becomes stable after the reversal. Thus, entry into the two-side conveyance path 33 becomes smooth, and reverse flow to the upper side in the reverse conveyance path 32 can be prevented without fail.

(2) When a sheet 5 enters the conveying roller 45 in the two-side conveyance path 33, the two-side roller 43 assists the conveyance. Thus, even if the sheet 5 is formed with heavy paper, the conveyance is smooth. (3) When the length of a sheet 5 being conveyed is shorter in the conveyance direction than the distance between the conveying roller 44 and the reversing roller 42 on the upstream side of the branch point PC, the rollers always serve to sandwich the sheet 5.

Further, as the conveying roller 44 and the two-side roller 43 are driven by the single motor 53, the costs can be made lower than the costs in a case where independent drive sources are prepared. In addition to that, the two-side roller 43 is disposed at a position closer to the branch point PB than the branch point PC. Accordingly, when switchback conveyance is performed by the two-side roller 43, the top edge 5A (the bottom side after the switchback) of the sheet passes through the two-side roller 43 more quickly. The conveyance direction is reversed immediately after the top edge 5A of the sheet 5 has passed through the two-side roller 43. At this point of time, the succeeding sheet should be yet to reach the conveying roller 44. As the preceding sheet 5 quickly passes through the two-side roller 43, a longer time is left for reversing the conveyance direction before the succeeding sheet enters the conveying roller 44.

According to the above described embodiment, the drive source for the reversing roller 42 is different from the drive source for the two-side roller 43 and the conveying roller 44. Thus, the productivity of printing involving reverse ejection can be increased. If the reversing roller 42 and the two-side roller 43 share a drive source as in the conventional examples, switchback conveyance must be completed before the succeeding sheet arrives at the conveying roller 44 in a case where reverse ejection is performed. To satisfy this requirement, it is necessary to lower the processing speed V1, which results in a tower productivity.

In the configuration of the above described embodiment shown in FIGS. 1 through 3, there is no need to prepare any mechanism for actively switching the course of a sheet 5 at both the branch point PB and the branch point PC, and a sheet 5 can be guided to the reverse ejection conveyance path 34 or the two-side conveyance path 33 by the return stoppers 62 and 63. As the drive components and the control on the drive components are not necessary, the costs can be lowered accordingly.

In the above described embodiment, the configuration of the entire image forming apparatus 1 or each component of the image forming apparatus 1, the details or the timing of conveyance control, the shape and the length of the conveyance path 30, the number of conveying rollers other than the reversing roller 42 and the two-side roller 43, the interval between the conveying rollers, and the like can be changed as appropriate within the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image former that forms an image on a sheet;
a main conveyance path that conveys the sheet being ejected from the image former to a downstream side;
a reverse conveyance path that branches from the main conveyance path and reverses the sheet;
a two-side conveyance path that branches at a first branch point of the reverse conveyance path and sends the sheet back into the image former for two-side printing;
a reverse ejection conveyance path that branches at a second branch point of the reverse conveyance path and sends the sheet to a downstream side of the main conveyance path for reverse ejection;
a two-side roller that is disposed in the reverse conveyance path, the two-side roller rotating to reverse a direction of conveyance of the sheet being conveyed in the reverse conveyance path and send the sheet into the two-side conveyance path; and
a reversing roller that is disposed in the reverse conveyance path, the reversing roller rotating to reverse the direction of conveyance of the sheet being conveyed to the reverse conveyance path and send the sheet into the reverse ejection conveyance path,
wherein the reversing roller is disposed on a downstream side or the two-side roller, as viewed from an ejection side of the image former.

2. The image forming apparatus according to wherein a conveyance velocity of the sheet in the reverse conveyance path is higher than a conveyance velocity of the sheet being ejected from the image former.

3. The image forming apparatus according to claim 1, further comprising a first controller that controls a rotation velocity of the reversing roller so that a conveyance velocity of the sheet being conveyed from the main conveyance path into the reverse conveyance path differs from a conveyance velocity of the sheet reversed by the reversing roller and being conveyed in the reverse ejection conveyance path.

4. The image forming apparatus according to claim 1, wherein a conveyance velocity of the sheet in the two-side conveyance path is higher than a conveyance velocity of the sheet being ejected from the image former.

5. The image forming apparatus according to claim 1, further comprising
a second controller that controls a rotation velocity of the two-side roller so that a conveyance velocity of the sheet being conveyed from the main conveyance path into the reverse conveyance path differs from a conveyance velocity of the sheet reversed by the two-side roller and being conveyed in the two-side conveyance path.

6. The image forming apparatus according to claim 1, wherein the two-side roller is disposed between the first branch point and the second branch point.

7. The image forming apparatus according to claim 6, wherein
a conveying roller for conveying the sheet in the reverse conveyance path is disposed between a branch point from the main conveyance path and the first branch point in the reverse conveyance path,
the two-side roller is disposed at a position closer to the second branch point than the first branch point, and
the conveying roller and the two-side roller are rotationally driven by the same drive source.

8. The image forming apparatus according to claim 1, wherein the two-side roller and the reversing roller are rotationally driven by drive sources different from each other.

9. The image forming apparatus according to claim 1, further comprising
a return stopper at each of the first branch point and the second branch point,
wherein,
when the sheet is conveyed to a downstream side in the reverse conveyance path, the return stopper guides the sheet to move along the reverse conveyance path, and,
when the sheet is conveyed to an upstream side in the reverse conveyance path, the return stopper guides the sheet to enter to one of the two-side conveyance path and the reverse ejection conveyance path from the reverse conveyance path.
